(19) United States
(12) Patent Application Publication
(10) Pub. No.: US 2016/0008825 A1
(43) Pub. Date: Jan. 14, 2016

(54) SPRAY APPLICATOR TOOL

(71) Applicant: Carlisle Fluid Technologies, Inc., Charlotte, NC (US)

(72) Inventor: Mitchell M. Drozd, Harwood Hts., IL (US)

(21) Appl. No.: 14/794,520

(22) Filed: Jul. 8, 2015

Related U.S. Application Data
(60) Provisional application No. 62/022,496, filed on Jul. 9, 2014.

(51) Int. Cl. B05B 1/30; B05B 15/06; B05B 7/12

(52) U.S. Cl. CPC B05B 1/30; B05B 7/12; B05B 15/065

(57) ABSTRACT

A system including a spray applicator assembly, including a spray applicator body, a spray applicator component coupled to the spray applicator body, and a spray applicator tool coupled to the spray applicator assembly, wherein the spray applicator tool is configured to adjust one or more parameters of the spray applicator assembly during an operational state, and the spray applicator tool is configured to couple to the spray applicator component and to facilitate removal of the spray applicator component during a non-operational state.

### CROSS-REFERENCE TO RELATED APPLICATIONS

This application is a non-provisional application claiming priority to US Provisional Patent Application No. 62/022,496, entitled “Spray Applicator Tool”, filed Jul. 9, 2014, which is herein incorporated by reference in its entirety for all purposes.

### BACKGROUND

The invention relates generally to spray devices, and more particularly, to a spray applicator tool.

Spray coating devices, such as spray guns, are used to apply a spray coating (e.g., paint) to a wide variety of target objects. Spray coating devices often include many reusable and/or wear components, such springs, seals, etc. Unfortunately, a considerable amount of time is spent removing portions of a spray coating device in order to access and replace these reusable components. Furthermore, removal of certain parts of the spray coating device may involve the use of external tools that can potentially damage parts of the spray coating device.

### DRAWINGS

These and other features, aspects, and advantages of the present invention will become better understood when the following detailed description is read with reference to the accompanying drawings in which like characters represent like parts throughout the drawings, wherein:

FIG. 1 is a perspective view of an embodiment of a spray applicator assembly with a spray applicator tool capable of removing a spray applicator piston;

FIG. 2 is a cutaway perspective view of an embodiment of a spray applicator assembly with a spray applicator tool capable of removing a spray applicator piston;

FIG. 3 is a partially exploded cutaway perspective view of an embodiment of a spray applicator assembly with a spray applicator tool capable of removing a spray applicator piston;

FIG. 4 is a cutaway perspective view of an embodiment of a spray applicator assembly with a spray applicator tool coupled to the spray applicator piston;

FIG. 5 is a cross-sectional view of an embodiment of a spray applicator tool coupling to an external surface of a spray applicator piston;

FIG. 6 is a cutaway view of an embodiment of a spray applicator tool coupling to a spray applicator piston with a protrusion;

FIG. 7 is a cross-sectional view of an embodiment of a spray applicator tool with a magnet that couples to a spray applicator piston; and

FIG. 8 is a side view of an embodiment of a spray applicator tool with a gripping recess.

### DETAILED DESCRIPTION

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements.

The present disclosure is generally directed to a spray applicator assembly with a spray applicator tool with multiple purposes. For example, during spraying operations the spray applicator tool may enable adjustment of spraying parameters of the spray applicator assembly. After spraying, the spray applicator tool may facilitate disassembly of a spray applicator assembly. More specifically, the spray applicator tool may include a coupling feature that enables the spray applicator tool to couple to a spray applicator piston within a spray applicator body. Once coupled, the spray applicator tool enables the user to pull the spray applicator piston out of the spray applicator assembly for maintenance (e.g., cleaning, replacement of gaskets, etc.). In some embodiments, the coupling feature may include threads that engage threads on the spray applicator piston. In another embodiment, the coupling feature may include a protrusion that engages a groove on the spray applicator piston. In still another embodiment, the spray applicator tool may include a magnet that enables the spray applicator tool to magnetically couple to the spray applicator piston. Moreover, the spray applicator tool may include any combination of these different coupling features. Finally, in some embodiments, the spray applicator tool may include a gripping feature that enables a user to better grip the spray applicator tool when removing the spray applicator piston.

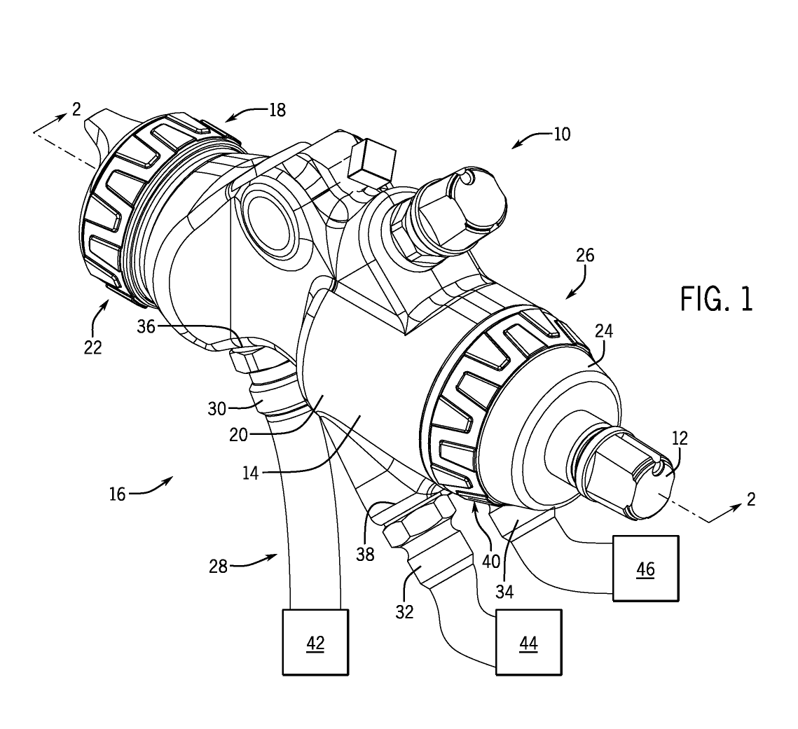

FIG. 1 is a perspective view of an embodiment of a spray applicator assembly 10 (e.g., a spray gun assembly) with a spray applicator tool 12 (e.g., a spray gun tool). As explained above, the spray applicator tool 12 may have multiple purposes including removing a spray applicator piston 14 out of a spray applicator 16 (e.g., a spray gun) during maintenance (e.g., gasket replacement, cleaning, etc.) and adjusting spraying parameters. As illustrated, the spray applicator assembly 10 includes a spray tip assembly 18 coupled to a spray applicator body 20 on a first end 22, and a piston housing cap 24 coupled to the spray applicator body 20 on a second end 26. Both the spray tip assembly 18 and the piston-housing cap 24 may threadingly couple or otherwise attach to the spray applicator body 20. In operation, the spray applicator assembly 10 receives fluid flow through fittings 28. These fittings 28 may include a liquid fitting 30, an atomization air fitting 32, and a piston air fitting 34. The fittings 30, 32, and 34 couple to the respective inlets 36, 38, and 40 in the spray applicator body 20 and to the respective liquid source 42, compressed air source 44, and compressed source 46. Once engaged, the spray applicator assembly 10 produces an atomized spray of a solvent, paint, sealer, stain, etc. with a desired spray pattern and droplet distribution.

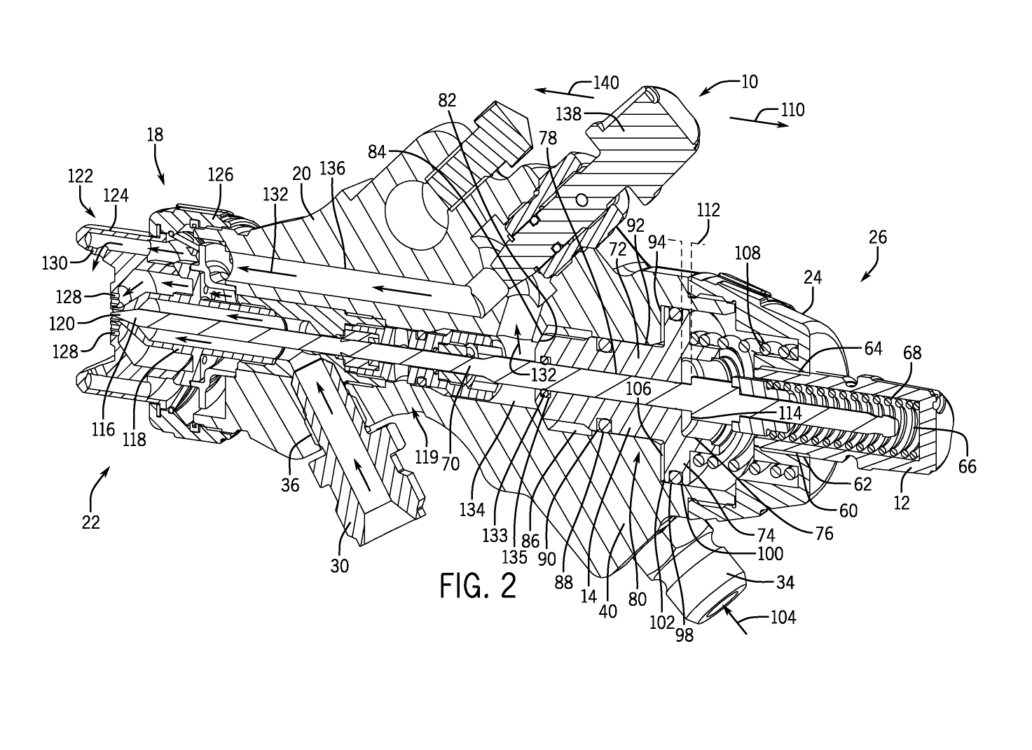

FIG. 2 is a cutaway perspective view of an embodiment of a spray applicator assembly 10 with a spray applicator tool 12 capable of removing a spray applicator piston 14 from the spray applicator body 20 for servicing without the use of additional tools. The spray applicator tool 12 couples to the piston-housing cap 24 with tool threads 60 that engage threads 62 in the cap bore 64. As illustrated, the spray applicator tool 12 may also include a cavity 66 that receives a valve spring 68 and a portion of a valve 70. In operation, the spray applicator tool 12 remains on the spray applicator assembly 10 and threads into and out of the piston housing cap 24 to increase and decrease the compression of valve spring 68, which then increases or decreases the force necessary to unseat the needle valve 70 for spraying.

As illustrated, the piston housing cap 24 couples (e.g., threads) to the spray applicator body 20, which houses the spray applicator piston 14. The spray applicator piston 14 includes a piston body 72 (e.g., cylindrical or annular), an annular lip 74, a piston counterbore 76 (e.g., cylindrical or annular), and a valve aperture 78 (e.g., cylindrical or annular). The spray applicator piston 14 couples to the spray applicator assembly 10 by inserting the piston body 72 into a cavity 80 (e.g., annular cavity) in the spray applicator body 20. The piston body 72 passes through the cavity 80 until an end face 82 of the spray applicator body 20 contacts a first counterbore 84 of the spray applicator body 20. Together, the first counterbore 84 and the spray applicator piston 14 form an airflow chamber 86 (e.g., cylindrical or annular) that contains air entering the spray applicator body 20 through the atomization air fitting 32 (seen in FIG. 1). In order to control the atomization airflow, the spray applicator piston 14 forms a seal around the airflow chamber 86 with the end face 82 and one or more gaskets 88 (e.g., cylindrical or annular). For example, the spray applicator piston 14 may include one or more gaskets 88 (e.g., 1, 2, 3, 4, 5 or more) that rest within cylindrical or annular grooves 90 (e.g., 1, 2, 3, 4, 5 or more) along the piston body exterior surface 92. In a seated position, the end face 82 and the first counterbore 84 seal the airflow chamber 86 in combination with the gaskets 88. In some embodiments, the end face 82 and/or the first counterbore 84 may be angled to facilitate contact and sealing.

In order to open the airflow chamber 86 during spraying operations, the spray applicator piston 14 forms a piston air chamber 94 with the spray applicator body 20. As illustrated, the annular lip 74 rests within a second counterbore 96 (e.g., cylindrical or annular) of the cavity 80 and includes a gasket 98 (e.g., cylindrical or annular) in a groove 100 (e.g., cylindrical or annular) along an exterior surface 102 of the annular lip 74. The gaskets 88 and 98 form seals between the spray applicator piston 14 and the spray applicator body 20 enabling piston air 104 to enter the piston air chamber 94 to drive the spray applicator piston 14. More specifically, as piston air 104 enters the piston air chamber 94 through the piston air fitting 34, the piston air 104 increases the pressure acting on a first lip surface 106. As the pressure increases in the piston air chamber 94, the pressure overcomes the biasing force of a piston spring 108, enabling the spray applicator piston 14 to move in direction 110. As the spray applicator piston 106 moves in direction 110, the spray applicator piston 106 compresses the piston spring 110 a distance 112 until the piston counterbore 76 contacts a valve lip 114. Further movement of the spray applicator piston 14 in direction 110 enables the spray applicator piston 14 to overcome the biasing force of the valve spring 68 driving the valve 70 in direction 110, which unseats the valve 70.

As illustrated, the valve 70 extends from the first end 22 of the spray applicator body 20 to the second end 26 of the spray applicator body 20. As the valve 70 extends from the first end 22 to the second end 26, the valve 70 passes through the valve aperture 78 in the spray applicator piston 14 and through a fluid packing assembly 119. At the first end 22, the valve 70 rests within the spray tip assembly 18 to control the flow of liquid through the spray applicator assembly 10. In a seated position, a tip 116 of the valve 70 blocks the flow of liquid through a liquid delivery tip assembly 118 of the spray tip assembly 18, while the fluid packing assembly 119 blocks liquid flow around the valve 70 and through the cavity 80 in direction 110. In the unseated position, the valve 70 enables fluid flow through the liquid delivery tip assembly 118. As explained above, the valve 70 unseats when piston air 104 enters the piston air chamber 94 driving the spray applicator piston 72 in direction 110 and into contact with the valve lip 114. In the unseated position, the valve 70 enables liquid to enter the spray applicator body 20 through the liquid fitting 30. As the liquid passes through the liquid fitting 30, the liquid enters the liquid deliver tip assembly 118, which then directs the liquid to a liquid tip aperture 120 where the liquid exits the spray applicator assembly 10. As the liquid exits, the spray tip assembly 18 atomizes and shapes the liquid with airflow through a spray formation assembly 122.

The spray formation assembly 122 couples to the liquid delivery tip assembly 118 and may include a variety of spray formation mechanisms, such as air, rotary, and electrostatic atomization mechanisms. However, the illustrated spray formation assembly 122 comprises an air atomization cap 124, which is removably secured to the spray applicator body 20 via a retaining nut 126. The air atomization cap 124 may include a variety of air atomization orifices 128 disposed about the liquid delivery tip assembly 118 enabling atomization of the liquid. The air atomization cap 122 may also have one or more spray shaping air orifices 130, which use air jets to shape the atomized liquid into a desired spray pattern (e.g., a flat spray). In operation, the spray formation assembly 122 receives airflow through the air atomization fitting 32. As explained above, when piston air 104 enters the piston air chamber 94, the pressure drives the spray applicator piston 72 in direction 110. The movement of the spray applicator piston 14 in direction 110 unseats not only the valve 70, but also the end face 84 of the spray applicator piston 14 from the first counterbore 82. As the end face 84 moves in direction 110, the airflow chamber 86 opens enabling air 132 to flow out of the airflow chamber 86 and into the distribution chamber 134. In some embodiments, the spray applicator piston 14 may include a gasket 133 (e.g., annular or cylindrical) that rests within a groove 135 (e.g., annular or cylindrical) to block air 132 from flowing around the valve 70 through the spray applicator piston 14. In the air distribution chamber 134, the airflow 132 splits between flowing to the air atomization passages 128 or to the shaping air orifices 130 through the fan pattern passage 136. In some embodiments, the spray applicator assembly 10 may include fan pattern adjustment valve 138 to maintain and regulate the air pressure and flow of the air 132 out of the shaping air orifices 130. After spraying operations, the piston air 104 is cutoff enabling the piston spring 108 to drive the spray applicator piston 14 in axial direction 140, which reseats the end face 82 with the first counterbore 84 cutting off airflow into the air distribution chamber 134. In addition, as the spray applicator piston 14 moves in direction 140, the spray applicator piston 14 enables the valve spring 68 to reseat the valve tip 116 in the liquid delivery tip assembly 118.

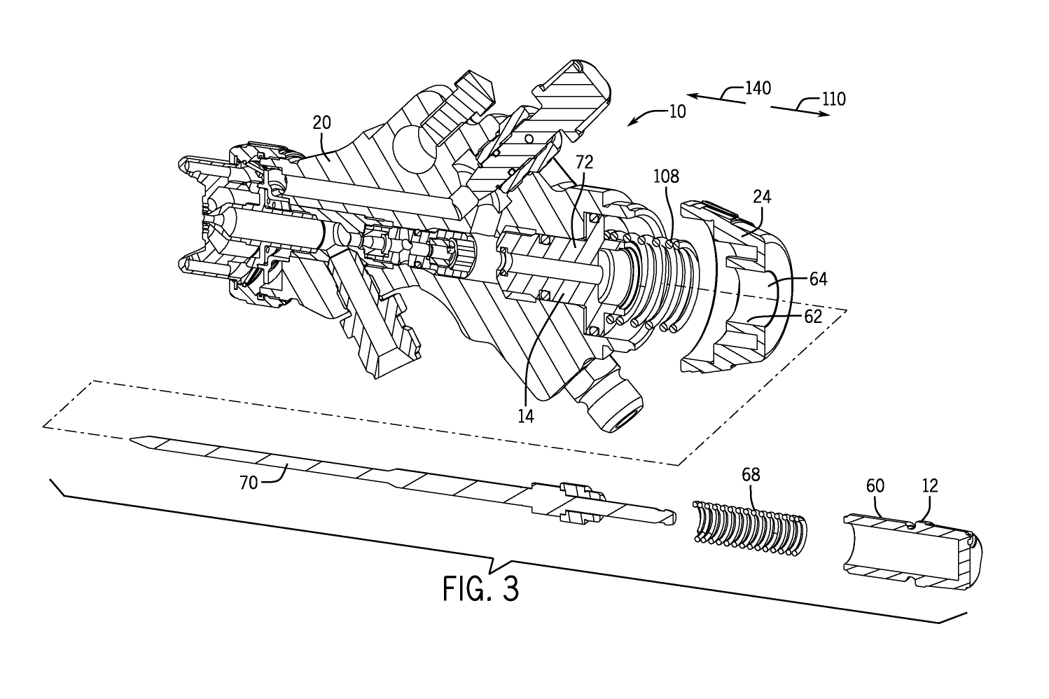

FIG. 3 is a partially exploded cutaway perspective view of an embodiment of a spray applicator assembly 10. As illustrated, the spray applicator removal tool 12 may be disassembled by unthreading the piston removal tool 12 from the housing cap 24 enabling the spray applicator removal tool 12 to couple to the spray applicator piston 14. After removing the piston removal tool 12, the valve spring 68 and the valve 70 may be pulled out of spray applicator assembly 10. The piston-housing cap 24 is also unthreaded from the spray applicator body 20 exposing the piston spring 108 and the spray applicator piston 14. In the alternative, the piston-housing cap 24 may be unthreaded before removing the valve spring 68 and the valve 70. In this disassembled state, the piston removal tool 12 may then couple to the spray applicator piston 14 enabling removal of the spray applicator piston 14 for maintenance and cleaning.

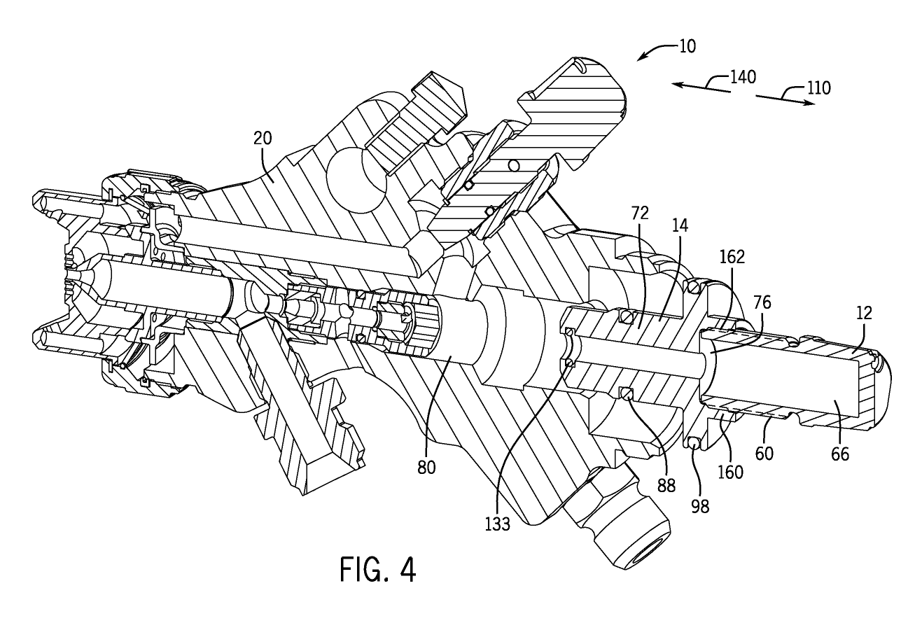

FIG. 4 is a cutaway perspective view of an embodiment of the spray applicator assembly 10 with the spray applicator tool 12 coupled to the spray applicator piston 14. In some embodiments, the spray applicator tool 12 may be threadingly coupled to the piston counterbore 76 in the piston body 72. For example, the tool threads 60 (e.g., male coupling) may engage corresponding piston threads 160 on an interior surface 162 of the piston counterbore 76. After the spray applicator tool 12 is threadingly coupled to the piston body 72, the spray applicator piston 14 may be easily removed from the spray applicator body 20 by pulling on the spray applicator tool 12 in direction 110. Once removed the gaskets 88, 98, and 133 may be replaced/inspected and/or other maintenance may be performed on the spray applicator piston 14 and spray applicator body 20 (e.g., cleaning, etc.).

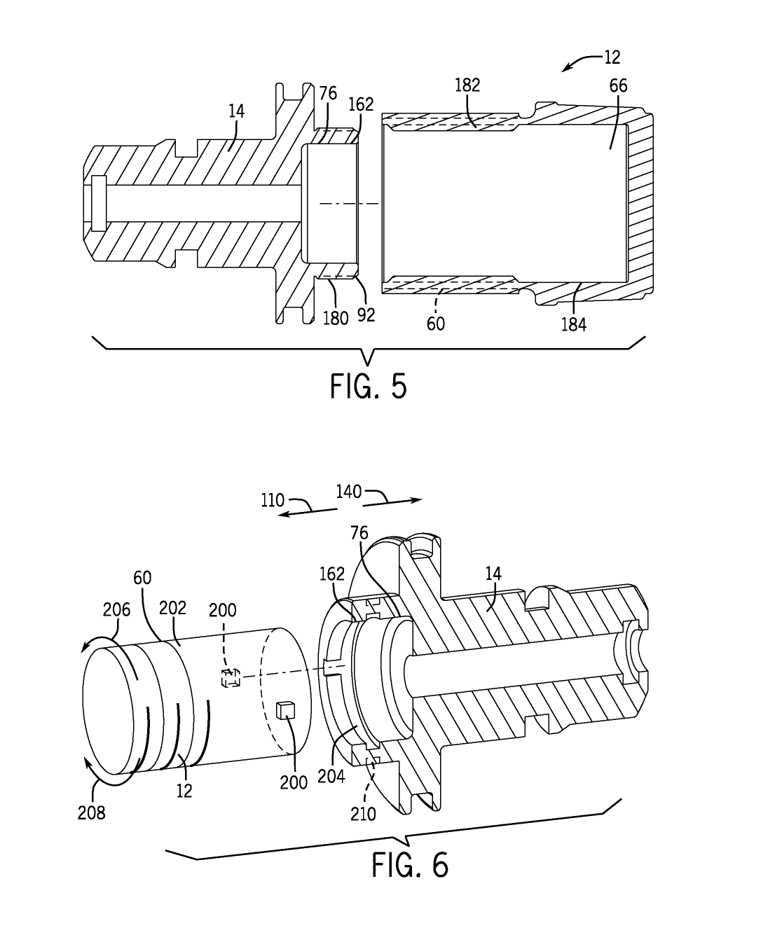

FIG. 5 is a cross-sectional view of an embodiment of the spray applicator tool 12 coupling to a spray applicator piston 14. In some embodiments, the spray applicator tool 12 may couple to the external surface 92 of the spray applicator piston 14. For example, the spray applicator piston 14 may include threads 180 on the exterior surface 92 around the counterbore 76. The threads 180 on the spray applicator piston 14 may threadingly engage threads 182 (e.g., female coupling) along an interior surface 184 of the spray applicator tool 12 in the cavity 66. Once coupled, the spray applicator tool 12 may be pulled in direction 110, enabling easy removal of the spray applicator piston 14 from the spray applicator body 20. In embodiments, where the spray applicator tool 12 includes threads 182 along an interior surface 184 the piston housing cap 24 may include a larger cap bore 64 that enables the threads 60 to couple to the piston housing cap 24 during operation of the spray applicator assembly 10.

FIG. 6 is a cutaway view of an embodiment of a spray applicator tool 12 coupling to a spray applicator piston 14 with a protrusion 200. As illustrated, the spray applicator tool 12 may include one or more protrusions 200 (e.g., 1, 2, 3, 4, 5, or more) on an exterior surface 202. The protrusions 200 enable the spray applicator tool 12 to couple to a circumferential groove 204 (e.g., annular groove) in the piston counterbore 76. In some embodiments, the spray applicator tool 12 is rotated in either direction clockwise direction 206 or counter-clockwise direction 208 until the protrusions 200 align with an axial groove 210 in the interior surface 162 of the piston counterbore 76. The spray applicator tool 12 is then moved axially in direction 140 until the protrusions 200 enter the circumferential groove 204. After the protrusions 200 enter the circumferential groove 204, the spray applicator tool 12 is rotated in either direction 206 or 208 to couple the spray applicator tool 12 to the spray applicator piston 14. Once coupled, the spray applicator piston 14 may be pulled out of the spray applicator body 20 with the spray applicator tool 12. In some embodiments, the protrusions 200 may be on an interior surface 184 enabling the pins to couple to a groove 210 on an exterior surface 192 of the spray applicator piston 14. In another embodiment, the protrusions 200 may be spring-loaded pins (e.g., snap-fit coupling) that compress as the spray applicator tool 12 enters the piston counterbore 76 or as the spray applicator tool 12 extends over the exterior surface 192 of the spray applicator piston 14, enabling attachment without the axial grooves 210. As the protrusions 200 slide along the grooves 204 and 210, the protrusions 200 pop out and couple the spray applicator tool 12 to the spray applicator piston 14. In still another embodiment, the spray applicator piston 14 may include the protrusions 200 along the interior surface 162 of the piston counterbore that couple to a corresponding groove in the cavity 66 of the spray applicator tool 12. In this way, the spray applicator tool 12 may couple a groove on the spray applicator tool 12 to the protrusions 200 on the spray applicator piston 14, enabling removal of the spray applicator piston 14.

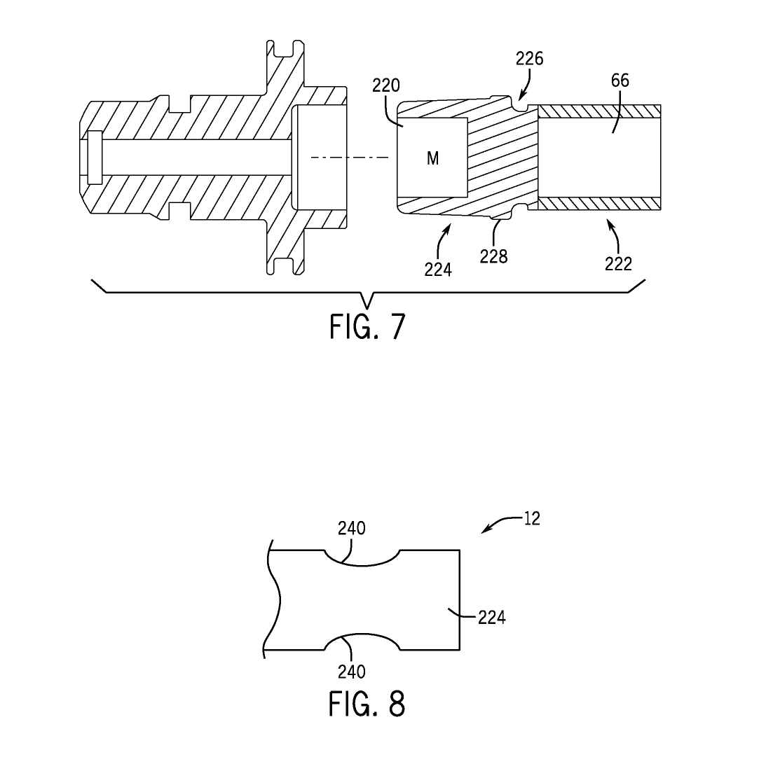

FIG. 7 is a cross-sectional view of an embodiment of a spray applicator tool 12 with a magnet 220 (e.g., a permanent magnet made of a magnetic material). In some embodiments, the spray applicator tool 12 may include the magnet 220 to enable the spray applicator tool 12 to couple magnetically to the spray applicator piston 14. As illustrated, the spray applicator tool 12 may include a first section 222 (e.g., annular body) and second section 224 (e.g., annular body). The first section 222 enables the spray applicator tool 12 to couple to the piston-housing cap 24 and to receive the valve 70 and valve spring 68. The second section 224 may be a user adjustment knob that enables a user to adjust the force on the valve 70 during use and to withdraw the spray applicator piston 14 after use. For example, the second section 224 may include the magnet 220 that magnetically attracts/couples to the spray applicator piston 14, enabling the spray applicator tool 12 to remove the spray applicator piston 14 from the spray applicator body 20. In addition, the second section 224 may include a gripping feature 226 that enables a user to better grip the spray applicator tool 12 when removing the spray applicator piston 14. In some embodiments, the gripping feature 226 may include the lip 228 that extends circumferentially about the entire circumference of the spray applicator tool 12. In other embodiments, the lip 228 may only extend partially around the spray applicator tool 12. In still other embodiments, the gripping feature 226 may include a plurality of spaced protrusions or teeth 228, disposed about the circumference, to enable a user to better grip the spray applicator tool 12 when removing the spray applicator piston 14.

FIG. 8 is a side view of an embodiment of a spray applicator tool 12 with a gripping feature 226. The gripping feature 226 in FIG. 8 is not a lip but a gripping recess 240. In some embodiments, the gripping recess 240 may extend circumferentially about the entire circumference of the spray applicator tool 12. In other embodiments, there may be a plurality of gripping recesses 240 at different axial and/or circumferential positions along the spray applicator tool 12 to facilitate a user's grip while pulling the spray applicator piston 14 out of the spray applicator assembly 14.

Technical effects of the disclosed embodiments include a spray applicator assembly 10 with a multi-purpose spray applicator tool 12. As explained above, the spray applicator tool 12 enables adjustment of spraying parameters during spraying operations and afterwards facilitates disassembly of the spray applicator assembly 10. The spray applicator tool 12 includes a coupling feature that enables the spray applicator tool 12 to couple to a spray applicator piston 14 within a spray applicator body 20. Once coupled, the spray applicator tool 12 enables the user to pull the spray applicator piston 14 out of the spray applicator assembly for maintenance (e.g., cleaning, replacement of gaskets, etc.).

While only certain features of the invention have been illustrated and described herein, many modifications and changes will occur to those skilled in the art. It is, therefore, to be understood that the appended claims are intended to cover all such modifications and changes as fall within the true spirit of the invention.

1. A system, comprising:
a spray applicator assembly, comprising;
a spray applicator body;
a spray applicator component coupled to the spray applicator body; and
a spray applicator tool coupled to the spray applicator assembly, wherein the spray applicator tool is configured to adjust one or more parameters of the spray applicator assembly during an operational state, and the spray applicator tool is configured to couple to the spray applicator component and to facilitate removal of the spray applicator component during a non-operational state.

2. The system of claim 1, wherein the spray applicator tool comprises at least one coupling feature configured to mate with the spray applicator assembly and the spray applicator component.

3. The system of claim 2, wherein the at least one coupling feature comprises a common coupling feature configured to selectively mate with both the spray applicator assembly and the spray applicator component.

4. The system of claim 2, wherein the at least one coupling feature comprises threads.

5. The system of claim 4, wherein the threads comprises male threads, female threads, or a combination thereof.

6. The system of claim 2, wherein the at least one coupling feature comprises a recess, a groove, or a combination thereof.

7. The system of claim 2, wherein the at least one coupling feature comprises a spring-loaded member, a snap-fit coupling, or a combination thereof.

8. The system of claim 2, wherein the at least one coupling feature comprises a magnetic coupling.

9. The system of claim 1, wherein the spray applicator tool comprises a gripping feature.

10. The system of claim 9, wherein the gripping feature comprises one or more recesses, one or more protrusions, or any combination thereof, along an exterior surface of the spray applicator tool.

11. The system of claim 1, wherein the spray applicator tool is configured to adjust the one or more parameters of a valve assembly in the spray applicator assembly.

12. The system of claim 1, wherein the spray applicator component comprises a spray applicator piston coupled to a valve assembly in the spray applicator assembly.

13. A system, comprising:
a spray applicator tool comprising a coupling feature, wherein the spray applicator tool is configured to couple to a spray applicator and adjust spray applicator parameters during spraying operations, and the spray applicator tool is configured to couple to a spray applicator piston with the coupling feature after spraying operations to facilitate removal of the spray applicator piston from the spray applicator.

14. The system of claim 13, comprising the spray applicator and the spray applicator piston.

15. The system of claim 14, wherein the coupling feature comprises first threads that couple to second threads on the spray applicator piston.

16. The system of claim 15, wherein the first threads couple to third threads on a piston housing cap.

17. The system of claim 14, wherein the coupling feature comprises a male coupling, a female coupling, a protrusion, a recess, a snap-fit coupling, a magnetic coupling, or any combination thereof.

18. A method, comprising:
adjusting an operational parameter on a spray applicator assembly with a spray applicator tool;
uncoupling the spray applicator tool from the spray applicator assembly;
coupling the spray applicator tool to a spray applicator piston of the spray gun assembly; and
removing the spray applicator piston from the spray applicator assembly with the spray applicator tool.

19. The method of claim 18, wherein coupling the spray applicator tool to the spray applicator piston comprises threadingly coupling the spray applicator tool with the spray applicator piston.

20. The method of claim 18, wherein coupling the spray applicator tool to the spray applicator piston comprises engaging a recess with a protrusion.
